(19) United States
(12) Patent Application Publication
(10) Pub. No.: US 2012/0153847 A1
(43) Pub. Date: Jun. 21, 2012

(54) Electronic Circuit for the Use of LEDs in an Alternate Current Power for Illumination Systems

(76) Inventors: Sidney Sigfried Skertchly Benavides, Monterrey (MX); Héctor Del Angel Soto, Monterrey (MX)

(21) Appl. No.: 13/330,427

(22) Filed: Dec. 19, 2011

(30) Foreign Application Priority Data
Dec. 20, 2010 (MX) MX/A/2010/014270

(51) Int. Cl. H05B 37/02

(52) U.S. Cl. 315/187; 315/192

(57) ABSTRACT

Electronic circuit for LEDs usage without the necessity of using converters or rectifiers takes advantage of the waves in both polarities from the source of alternating current, saving space and minimizing the number of components in the circuits. This circuit is formed by two LEDs series connected in parallel but with an inverse polarity, with or without Zener protection diodes. To this type of circuit, capacitive arrangements can be added to limit the total electric current of the circuit. This way when it operates in a sufficiently high frequency, the LEDs give the optical perception that they are turn on simultaneously. In the implementation of this circuit, the illumination and signaling systems obtains low cost devices, low energetic consumption and excellent illumination levels.

The present disclosure relates to Mexican Patent Application No. MX/a/2010/014270, filed Dec. 20, 2010, the content of which is hereby expressly incorporated herein in its entirely.

### FIELD OF THE DISCLOSURE

This disclosure relates to an electronic circuit for the use of LEDs (high and low luminosity) in alternating current for illumination systems.

### BACKGROUND

There are different types of circuits that use LEDs in illumination devices. These types of circuits use alternating current, with the objective to maintain the LEDs directly polarized during the whole time the circuit is being fed. There are two basic types of these circuits. The first type of circuit can reduce the fed wave amplitude and can convert the alternating current power to direct current power. It transforms the input magnitude of the wave into a manageable signal for the LEDs. The second type of circuit converts the alternating signal to a continuous signal by rectification. The rectification is the procedure by which one of the semi-cycles of the alternating signal changes its polarity to finally have both alternations in the same level. The rectification is made with rectification diodes, which are needed in an order of a minimum of 2 and a maximum of 4. To this number it must be added the number of elements used to obtain the direct component of the rectification wave.

These types of circuits have the following inconveniences:

1. It requires rectifiers or converters from alternating current to direct current.

2. It has a high number of electronic components to activate the LEDs in rectified conditions.

### BRIEF DESCRIPTION OF THE DRAWINGS

Embodiments of the disclosure are further described in the detailed description which follows, by reference to the noted drawings, in which like reference numerals represents similar parts throughout the several views of the drawings, and wherein:

FIG. 1 is a diagram of an exemplary single-pole LED;

FIG. 2 is a diagram of an exemplary zener diode;

FIG. 3 is a diagram of a two LEDs in parallel;

FIG. 4 is a diagram of an embodiment of a power regulator;

FIG. 5 is a diagram of another embodiment of a power regulator;

FIG. 6 is a diagram of an embodiment of circuit using LEDs with alternating current;

FIG. 7 is a diagram of another embodiment of circuit using LEDs with alternating current; and

FIG. 8 is a diagram of yet another embodiment of circuit using LEDs with alternating current.

### DETAILED DESCRIPTION

A circuit may be made of a minimum number of components, without rectifiers, without alternating current to direct current converters and low power consumption. Such a circuit allows for the elimination of the rectifier and minimization of the number of electronic components. It takes advantage of the input sinusoidal signal and puts the LEDs into operational status taking as a base for input a source of alternating current, achieving, this way, less costly illumination systems.

An electronic circuit for the use of LEDs, both high and low luminosity, can include an arrangement of LEDs that can be used directly with alternating current without the need to rectify the AC wave. In one exemplary embodiment, the circuit can be formed by a plurality of sets of LEDs, for example, two sets of LEDs. Each set of LEDs can be connected in sequence with one LED following the others. The sets of LEDs are connected in parallel such that the direction of the polarity of the LEDs in each set is opposed. Each set of LEDs can include any number of LEDs. The circuit can function by using the electric charge generated by the sets of LEDs. The circuit can avoid the addition of any other devices if the total charge calculation is made according to the wished alternating current source as a feed.

The circuit can also be functional if any other component or device is added in any position in the sets of LEDs. For example, an additional component or device can be added at the beginning of a set of LEDs and/or in between LEDs in a set and/or at the end of an LED set, and can limit and/or vary the voltage and/or electric power or protect and/or operate the LEDs. The circuit works with any alternate current independently of its shape and period if the peak voltage is enough to polarize the sets of LEDs in such a way as to turn on the LEDs and put them in operation.

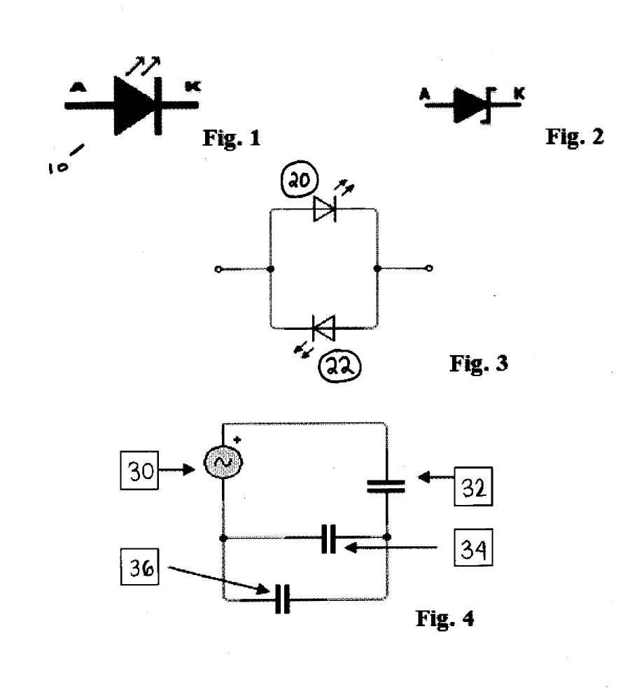

The LEDs are single-pole, meaning that the LEDs only conduct the electric current in one direction. In FIG. 1, the electric current enters an LED 10 at location A and exits the LED 10 goes out at location K. If the polarity of the electric current is inversed, the LED 10 will not conduct.

FIG. 3 illustrates an example of a circuit in which the process is based. Two LEDs 20, 22 are put in parallel with each other, and the polarity of the LEDs 20, 22 are inverse to one another. If the circuit shown in FIG. 3 is fed with alternating current, when the positive cycle of the alternating current is happening, one of the LEDs 20 will be conducting and the opposite LED 22 will not be conducting (i.e, LED 22 will be turned off). When the alternating current changes to the opposite polarity, the LED 20 that was conducting will turn off and the LED 22 that was off will turn on and begin conducting. It is important to clarify that if the input frequency is high enough, the human perception of this effect is equal to seeing both LEDs 20, 22 as being turned on.

The circuit previously described in FIG. 3 will be fed by an arrangement of capacitors in two different configurations. This configuration of capacitors can be called a power regulator because it works to restrain the electric current or reduce the voltage in the circuit.

FIG. 4 shows a first embodiment of power regulator, which is in the form of a capacitive Voltage Divider. The functioning of this circuit is supported by Kirchhoff's Voltage Law. It can be seen that the circuit's principal loop (or net 1) is formed by the feed source 30, a capacitor 32, and a capacitor 43. The voltage of the feed source 30 is equal to the sum of the voltage fall of the capacitors 32, 34, such that Vi=V_{C1}+V_{C2}. The terminals that feed the circuit are the ones in the capacitor 32, so the capacitor voltage of the capacitor 32 is obtained by the formula V_{C1}=Vᵢ−V_{C2}. For example, if the voltage source is 125 V alternate current, the voltage fall in the capacitor 32 is 83. 1 V if C=1 μF, the voltage drop in the capacitor 34 equals that of capacitor 36 and is of 41.9 V if C=1 μF, if applying the principle previously explained, this is true.

FIG. 5 shows a second embodiment of a power regulator. It is in the form of a capacitive current limiter. In this configuration, the circuit includes an arrangement of capacitors 42 in parallel that ranges from zero to “n” of “x” capacitance and is connected to one of the terminals of a feed source 40. The other terminal in the arrangement of capacitors 42 is connected such that it feeds a circuit such as the circuit shown in FIG. 3. The other feeding terminal to the circuit is directly connected to the second terminal of the feed source 40. The current delivered by the capacitive arrangement 42 depends on the equivalent capacitance of the arrangement of capacitors 42.

Based on this principle, different circuits were made that are described next. The circuits can also be functional if any component or device is added in any of the series of LEDs, at either the beginning and/or in between LEDs in the series and/or at the end of the LED series, that limits and/or varies the voltage and/or electric power or protects and/or operates the LED's. The circuit works with any alternate current independently of its shape and period if the peak voltage is enough to polarize the LED's arrangement in such a way they get in operation.

### Example 1

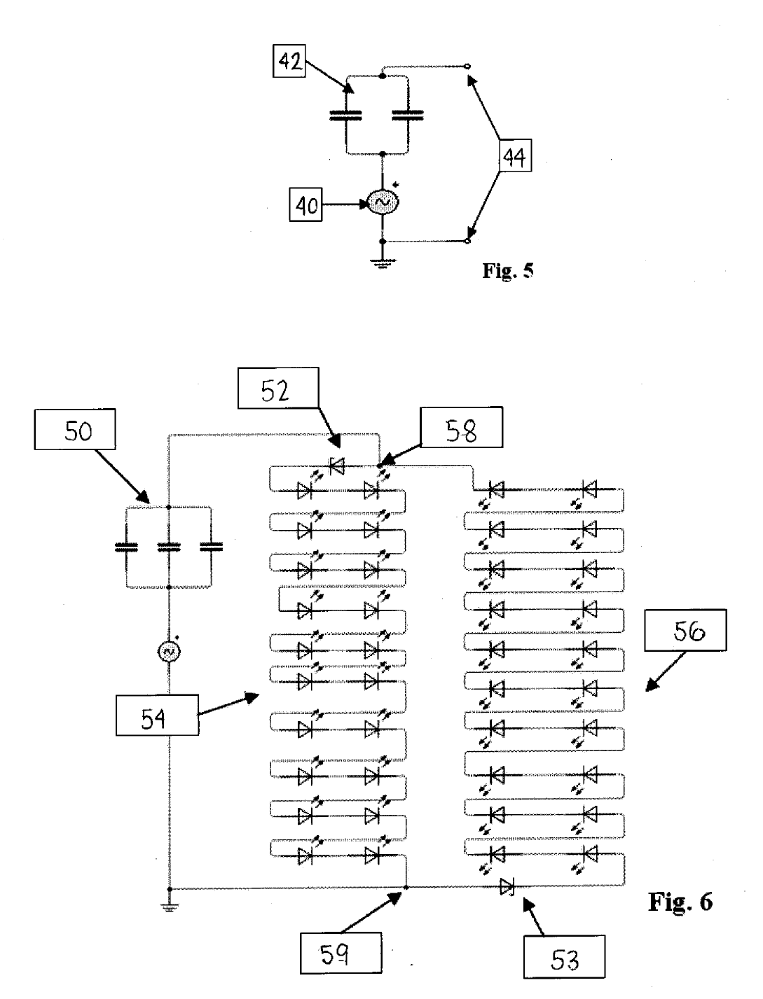

With an electric power limiter, a circuit was implemented in an arrangement shown in FIG. 6 formed by two sets of LEDs 54, 56. Both sets of LEDs 54, 56 are made of 20 LEDs connected in sequence, such that, as shown in FIG. 1, the terminal K from the first LED is connected to the terminal A of the next LED, and so on, and thus successively maintaining the same direction in polarity in order to avoid the interruption of the electric power flow. At the beginning of each of the series, there is a Zener diode 52, 53, as shown in FIG. 2. The terminal K of the Zener diode 52 is connected to the terminal A of the first LED in the set 54. The terminal A from each Zener diode (as shown in FIG. 2) connects in a sequence to the terminal K from the last LED from the other set 52, being then connected in parallel, but the direction of the polarity is opposed (forming the nodes 58 and 59). At the node 58, there is a connection in sequence to 3 capacitors 50, and the capacitors 50 are connected in parallel among them.

The capacitor arrangement 50 shown in FIG. 6 works according to the second embodiment of the power regulator shown in FIG. 5. The other connection point of the capacitor arrangement 50 is directly connected to the power source of the circuit of FIG. 6.

Thus, the two sets of LEDs 54, 56 will be alternating depending on the polarity of the alternating current in the circuit. While one set of LEDs is on and conducting, the other set of LEDs is off. In the next alternation of the current, the conditions in the two sets of LEDs will be inversed.

To assure that no inverse current flow exists in the LEDs, a zener diode can be used to prevent the LEDs' deterioration. The zener diode works when the set of LEDs that it belongs to is inversely polarized (off), such that the zener diode limits the inverse electric flow.

### Example 2

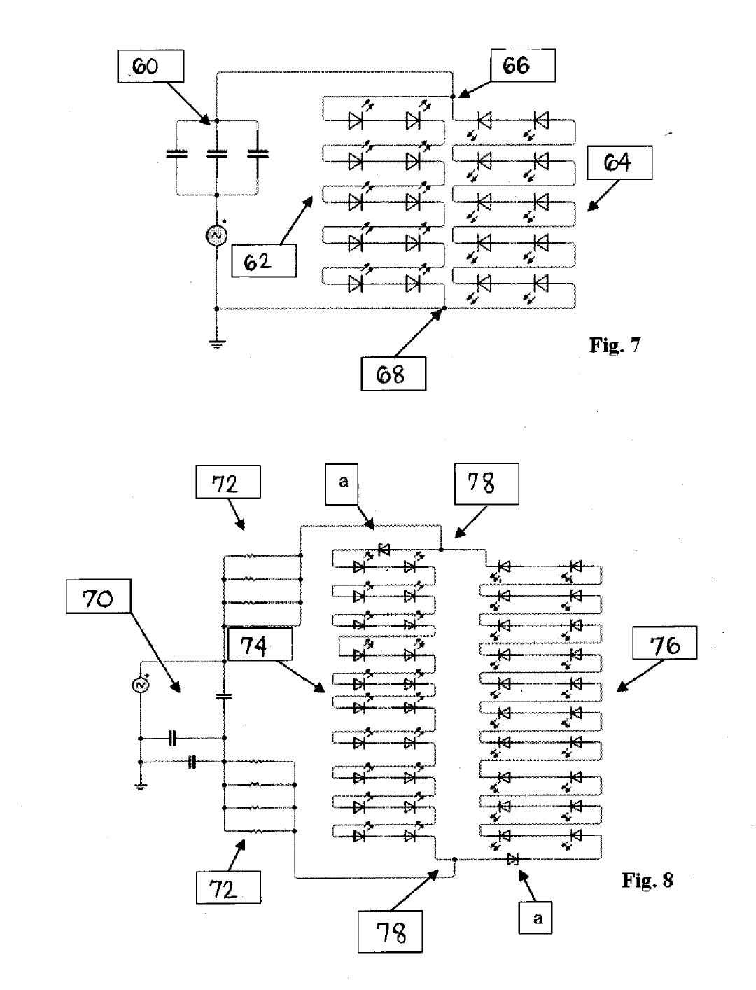

The scheme shown in FIG. 7 is based on the functioning principle of the LEDs from FIG. 3 and it is formed by 2 sets of 10 LEDs with each LED being connected in a sequence from the first one to the last. The terminal A from the first LED of the first set of LEDs is connected to the terminal K of the last LED of the second set of LEDs (see FIG. 1) to form a node 66. The last LED of the first set of LEDs and the first LED of the second set of LEDs are connected to form a node 68. The capacitors 60, that are connected in parallel, work as an electric current limiter. In this circuit, a Zener diode was omitted with the purpose of reducing the number of components in the circuit. Without this device the circuit works in the same way because the LEDs are diodes too and only conduct current in one direction. When the equivalent to a 180° of the feed alternating current is in opposed polarity to the polarity of the LEDs, an inverse polarity current is created in the circuit. Even though in some kinds of LEDs the useful life of the LED can be reduce, the circuit is functional without the addition of the Zener diode.

### Example 3

As shown in a circuit of FIG. 8, a section 70 of the circuit corresponds to the capacitive voltage reducer described above. In a section 72 of the circuit, there are 4 resistances connected in parallel among them, and the resistances are connected in sequence with the union node 78. This arrangement has the objective of dividing the heat produced by the electric current bypass and of avoiding a situation in which only one resistance supports all the current, rather than the equivalent of the 4 resistances in parallel which support all the electric current and the heat produced by the circuit. The voltage reducer 70 that feeds the circuit diminishes the input wave amplitude and produces a regulated electric flow. This electric current is divided in equal parts to pass through the resistances that are of the same magnitude in section 72 , which implies that each resistance supports one fourth of the total heat. When a semi-cycle of the wave occurs, it will turn on the set of LEDs that coincides with the polarity of the current, while the other set of LEDs will remain turned off and the inverse current of polarization will be limited by the Zener diode. When the polarity of the current changes, the conditions of the sets of LEDs will be inverted.

The claims as originally presented, and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. An apparatus, comprising:
an electronic circuit for the use with LEDs wherein the circuit comprises two sets of LEDs) that are connected in parallel among themselves such that the direction of the polarity is opposed in each set of LEDs;
wherein the electric charge generated by the sets of LEDs when an alternating current is passed through the circuit is used to power the circuit.

2. The apparatus of claim 1, wherein the LEDs in each LED series are connected in sequence one following the other.

3. The apparatus of claim 1, further comprising a Zener diode implemented as a protection measure for the LEDs when they are inversely polarized.

4. The apparatus of claim 1, wherein the circuit further comprises an arrangement of capacitors implemented at the circuit input ranging from zero capacitors of “x” capacitance, to “n” capacitors depending on the electric charge of the circuit.

5. The apparatus of claim 4, wherein the capacitors are connected in parallel with one another and in series with one of the source terminal or in a way of a capacitive voltage divider.
